(19) United States
(12) Patent Application Publication
(10) Pub. No.: US 2023/0128169 A1
(43) Pub. Date: Apr. 27, 2023

(54) POURABLE LIQUID FORMULATIONS OF SOLID WETTING AGENTS

(71) Applicants: Nicholas G. Moon, Greer, SC (US); Jimmy M. Stokes, Duncan, SC (US); Shirley A. Whiteside, Chesnee, SC (US)

(72) Inventors: Nicholas G. Moon, Greer, SC (US); Jimmy M. Stokes, Duncan, SC (US); Shirley A. Whiteside, Chesnee, SC (US)

(73) Assignee: Milliken & Company, Spartanburg, SC (US)

(21) Appl. No.: 17/962,589

(22) Filed: Oct. 10, 2022

Related U.S. Application Data
(60) Provisional application No. 63/272,231, filed on Oct. 27, 2021.

(51) Int. Cl. C09K 17/18

(52) U.S. Cl. CPC C09K 17/18

(57) ABSTRACT

The present invention relates to wetting agent formulations comprising wetting agents combined with co-additives that ensure the wetting agent formulation is a flowable liquid at room temperature. Wetting agents suitable for use in this invention are multi-branched block copolymers. The copolymers include a polyfunctional base which is an oxygen-containing compound having at least three ethylene oxide/propylene oxide block copolymer branches attached thereto. The co-additives include a combination of a solvent with an intermediate-to-high polar parameter and a low hydrogen bonding parameter and a solvent with intermediate-to-high hydrogen bonding parameter, as defined by Hansen's solubility parameters.

### CROSS REFERENCE TO RELATED APPLICATIONS

This application claims priority to U.S. Provisional Patent Application No. 63/272,231, entitled “Pourable Liquid Formulations of Solid Wetting Agents,” which was filed on Oct. 27, 2021, and is entirely incorporated by reference herein.

### TECHNICAL FIELD

The present invention relates to wetting agent formulations comprising wetting agents combined with co-additives that ensure the wetting agent formulation is a flowable liquid at room temperature. Wetting agents suitable for use in this invention are multi-branched block copolymers. The copolymers include a polyfunctional base which is an oxygen-containing compound having at least three ethylene oxide/propylene oxide block copolymer branches attached thereto. The co-additives include a combination of a solvent with an intermediate-to-high polar parameter and a low hydrogen bonding parameter and a solvent with intermediate-to-high hydrogen bonding parameter, as defined by Hansen's solubility parameters.

### BACKGROUND

Wetting agents are used in managed turf environments to prevent dry spot formation and reduce water usage. These wetting agents, also known as soil surfactants, are typically sold as high activity blends, and are normally diluted into water before spraying onto the turf. Many soil surfactant products are linear, block copolymers of ethylene oxide (EO) and propylene oxide (PO). Others include branched EO/PO block copolymers which have been demonstrated to be successful wetting agents, providing improved wetting behavior and longevity. However, there continues to be a need for improving the wetting agent performance, particularly over long application time frames and under drought conditions. Under drought conditions, wetting agents which increase the water content of the soil are valuable. Retaining water in the soil improves availability of water to the plant roots, improving plant health and appearance.

As an additional challenge, the simplest method to apply the wetting agent to the turf would be to use the product as a high-activity liquid. These products could be readily poured into mixing tanks and diluted with water prior to spraying. As many EO/PO block copolymers, especially those with higher weight percentages of EO, are pastes or flakes, methods to produce high activity products that are pourable liquids which would expand the range of surfactant structures available in a managed turf environment would be desirable.

Hansen's Solubility Parameters (HSP) are a formalism that describes the interaction between a solvent and a solute in terms of their dispersive (δD), polar (δP) and hydrogen-bonding (δH) components. By matching the HSP of the solvent (or solvents) and the solute as closely as possible, the favorable interactions, and thus solubility, are maximized. HSP can be experimentally determined by attempting to dissolve the solute in a wide variety of solvents. The solubility is rated and the data is fit to a model to generate the solute's HSP as well as the radius, which describes the range where the soluble to insoluble transition begins. An example of the software used can be found at https://www.hansen-solubility.com/HSPiP/. In addition, the reference book, “Solubility Science: Principles and Practice” by Professor Steven Abbott (Chapter 3, March 2021) provides additional detail about Hansen's Solubility Parameters.

The present invention addresses the shortcomings of prior art wetting agents and offers additional benefits over other types of soil surfactants by providing a pourable, liquid wetting agent formulation that improves wetting performance and longevity, leading to overall improved plant health.

### BRIEF SUMMARY

In one aspect, the invention relates to a wetting agent formulation comprising: (1) a wetting agent that includes at least one multi-branched block copolymer, said block copolymer having a polyfunctional base which is an oxygen-containing compound having at least three ethylene oxide/propylene oxide block copolymer branches attached thereto, and (2) co-additives that include a combination of: (a) a polar solvent and (b) a protic solvent; wherein the wetting agent formulation is a flowable liquid at room temperature.

### DETAILED DESCRIPTION

This invention relates to wetting agent formulations comprising wetting agents and co-additives that ensures the formulation is a flowable liquid at room temperature. Wetting agents suitable for use in the present invention are multi-branched block copolymers wherein the branches contain at least one alkoxylate component. In one aspect of the invention, the copolymers include a polyfunctional base which is an oxygen-containing compound having at least three ethylene oxide/propylene oxide block copolymer branches attached thereto. The base can be selected from a polyol, a polycarboxylic acid, and a lactone. The alkoxylate component is selected from ethylene oxide (“EO”), propylene oxide (“PO”), butylene oxide (“BO”), and combinations thereof. In one aspect of the invention, the alkoxylate includes from 40% to 90% EO, with 50% being most preferred, and from 10% to 60% PO, with 50% being most preferred. The EO and PO can be found in one or more blocks, a random copolymer, or mixtures of the two.

In one aspect of the invention, the multi-branched block copolymer contains a polyol base compound and is comprised of two to ten polymer-containing branches, or even two to eight polymer-containing branches, or even four to six polymer-containing branches, or even six polymer-containing branches.

In another aspect of the invention, at least one oxygen-containing polyfunctional base compound further contains at least one polyalkyleneoxy chain. The at least one polyalkyleneoxy chain may be a polymeric epoxide. The polymeric epoxide is selected from the group consisting of polyethylene oxides; polypropylene oxides; polybutylene oxides; oxetanes; tetrahydrafurans; copolymers of polyethylene oxides, polypropylene oxides and polybutylene oxides; and other copolymers including block copolymers. In another aspect of the invention, most of the polymeric substituent is polyethylene oxide, polypropylene oxide and/or polybutylene oxide.

In a further aspect, the multi-branched wetting agent includes at least one polyfunctional oxygen or nitrogen-containing polyfunctional compound. Such a polyfunctional compound may be a polyol, a polycarboxylic acid, a lactone (the ring structure of which will open upon reaction to provide the necessary reactive sites for surfactant addition thereto), an amino acid, or mixtures thereof, wherein the moieties include reactive end groups for reaction with surfactant-like groups to form the desired branches therein, or a polyamine. In such a base compound, the oxygen-containing functionalities (oxygen alone, or as part of a carboxylic acid group) provide the reactive sites and thus act as linking groups between the base compound and the surfactant-like branches. Alternatively, in cases where both oxygen-containing functionalities and nitrogen-containing functionalities are present, such as in amino acids, both functionalities may provide reactive sites which act as linking groups between the base compound and the surfactant-like branches.

Particular classes of polyols suitable for this purpose include, without limitation, tri- to octa-hydric alcohols such as pentaerythritol, diglycerol, α-methylglucoside, sorbitol, xylitol, mannitol, erythritol, dipentaerythritol, arabitol, glucose, sucrose, maltose, fructose, mannose, saccharose, galactose, leucrose, and other alditol or sugar molecules or polysaccharides; polybutadiene polyols; castor oil-derived polyols; hydroxyalkyl methacrylate copolymers; hydroxyalkyl acrylate polymers; polyvinyl alcohols; glycerine; 1,1,1-trimethylolpropane; 1,1,1-trimethylolethane; 1,2,6-hexanetriol; butanetriol; and mixtures thereof. Potentially preferred base compounds are the alditol types, particularly sorbitol and sucrose. The polyol can also be a blend of two or more of the above components.

Suitable polycarboxylic acids include, without limitation, tartaric acid; citric acid; ascorbic acid; 2-phosphono-1,2,4-butane tricarboxylic acid; glucuronic acid; ethylenediaminetetraacetic acid; gluconic acid; cyclohexane hexacarboxylic acid; mellitic acid; saccharic acid; mucic acid; diethylenetriamine pentaacetic acid; glucoheptonic acid; lactobionic acid; 3,3′,4,4′-benzophenone tetracarboxylic acid; amino propyl trimethoxysilane; aminopropyltriethoxysilane; 3-glycidoxypropyltrimethoxy silane; 3-glycidoxypropyltriethoxysilane; 3-(triethoxysilyl)propyl isocyanate; 3-(trimethoxysilyl)propyl isocyanate; diaminopropane-N,N,N′,N′-tetraacetic acid; aconitic acid; isocitric acid; 1,2,3,4-butanetetracarboxylic acid; nitrilotriacetic acid; tricarballylic acid; N-(phosphonomethyl)iminodiacetic acid; 3-[[tris(hydroxymethyl)methyl]amino]-1-propanesulfonic acid; 2-[[tris(hydroxymethyl)methyl]amino]-1-ethanesulfonic acid; 3-[bis(2-hydroxyethyl)amino]-2-hydroxy-1-propanesulfonic acid; 3-[N-trishydroxymethylmethylamino]-2-hydroxypropanesulfonic acid; N-tris[hydroxymethyl]methyl-4-aminobutanesulfonic acid; 3-aminoadipic acid; 1,3-diamino-2-hydroxypropane-N,N,N′,N′-tetraacetic acid; triethylenetetraaminehexaacetic acid; β-carboxyaspartic acid; α-hydroxymethylaspartic acid; tricine; 1,2,3,4-cyclopentanetetracar-carboxylic acid; 6-phosphogluconic acid; and mixtures thereof.

Suitable lactones include, without limitation, glucoheptonic lactone and glucooctanoic-.gamma.-lactone. Suitable amino acids include, without limitation, aspartic acid, α-glutamic acid, and β-glutamic acid.

Suitable polyamines include but are not limited to ethylenediamine, diethylene triamine, triethylamine tetramine, pentaethylene hexamine, poly(ethylene imine), and polyvinylamine.

In another aspect of the invention, the above alkoxylates can be functionalized with hydrophobic end groups as follows:

R₁—(O—(CH₂CHR₂O)ₓ(CH₂CH₂O)_{y}COR₃)_{z}

wherein:

R₁ is a multi-functional oxygen-containing polyol with at least 3 oxygen-containing reactive sites, preferably from 3 to 10 oxygen-containing reactive sites;

R₂ is H, CH₃, CH₂CH₃, Ph, or CH₂OR₄ where R₄ is any alkyl, aryl or siloxane group;

R₃ is either a hydrophobic end group which contains a carbon chain with 4 or more carbons, preferably 4 to 20 carbons, or H, with at least one of the groups being the hydrophobic end group, with alkylsuccinic anhydride adducts and fatty esters being preferred and alkylsuccinic anhydride adducts being most preferred;

x is an integer from 1 to 200, preferably from 20 to 80, more preferably from 30 to 50;

y is an integer from 1 to 250, preferably from 100 to 250, more preferably from 200 to 250;

z is an integer from 3 to 10, preferably from 4 to 8, more preferably from 6 to 7.

Typically, the wetting agents described herein are solids at room temperature, making them difficult for the end customer to use. In this regard, the customer normally must add a high-activity liquid to a mix tank, dilute it with water, and then vigorously agitate the mixture to dissolve the wetting agents. In most instances, a waxy solid would be difficult, or even impossible, to use this way. The solidification is driven by the high molecular weight ethylene oxide blocks contained in some multi-branched wetting agents with intermediate and high weight % EO. Many of the preferred compositions described above are solids at room temperature due to the above-described factors. This invention is directed to the discovery that specific combinations of co-additives with the wetting agent ensure that the final mixture is a flowable liquid with a melting point below room temperature.

Co-additives suitable for use in the present invention include a combination of (1) a solvent with an intermediate to high polar parameter (δP) and low hydrogen bonding parameter (δH) as defined by Hansen's solubility parameters (referred to herein as the “polar solvent”), and (2) a solvent with an intermediate to high hydrogen-bonding parameter (δH) as defined by Hansen's solubility parameters (referred to herein as the “protic solvent”). The range of the polar parameter (δP) is 15 to 20, with 17 to 19 being most preferred. The H-bonding parameter (δH) is between 20 and 28, with a range of 25 and 27 being most preferred. Polar solvents include, but are not limited to, propylene carbonate, ethylene carbonate, dimethylsulfoxide, and combinations thereof. Propylene carbonate is most preferred. Protic solvents include, but are not limited to, water, glycerin carbonate, propylene glycol, ethylene glycol, urea, urea solutions, hydroxyethyl urea, hydroxyethyl urea solutions, and combinations thereof. Water, urea solutions, and hydroxyethyl urea solutions are more preferred. Most preferred are combinations of propylene carbonate and water. These solvents/additives are present in a ratio from 1:99 to 99:1 of the polar solvent to the protic solvent. More preferred are ratios of 1:5 and 5:1 of the polar solvent to the protic solvent. Most preferred are between 1:2 and 2:1 w:w of the polar solvent to the protic solvent.

The co-additives are present in the wetting agent formulation in the range from 1% to 35%, with a range from 20% to 40% being preferred, and with 30% to 35% being most preferred. The ratio of wetting agent to co-additive is in the range from 1.5:1 to 4:1, or even in the range from 1.2:1 to 1.8:1.

In addition to the above components, the wetting agent formulation may include one or more of the following: another compound that actively lowers the surface tension of water such as a phenol ethoxylate, an alkylphenol ethoxylate, an alcohol ethoxylate, an alkyl sulfate, and alkyl phosphate, a linear ethylene oxide/propylene oxide block copolymer such as L62, polyols, another unfunctionalized branched block copolymers like those discussed in U.S. Pat. No. 6,948,276 B2, an alkylpolyglycoside, or any other compound known in the art to function as a surfactant; a fertilizer; a pesticide; a biostimulant; a colorant; and combinations thereof.

This invention describes formulas that retain the high activity of the wetting agent while providing a liquid formula. The key discovery is that the combination of a polar solvent and a hydrogen-bonding parameter are uniquely capable of generating a liquid formula at room temperature. Without being bound by theory, it is hypothesized that the poly(ethylene oxide) segments contained within the block copolymer readily crystallize with each other. The forces have a significant polar and hydrogen bonding parameter, as described by Hansen's solubility parameters. By blending a polar solvent with a protic solvent, both parameters can be matched in a way that maximizes interaction between the solvent and the wetting agent. Because the interactions are maximized, crystallization is suppressed as evidenced by formation of a stable, clear liquid formula. If only a polar or protic solvent is used, the interactions are not maximized and the material is either cloudy or a solid (see examples). More of the solvent will be required to produce a clear solution.

### EXAMPLES

The following Examples are provided for illustration purposes and should not be considered as limiting the scope of the invention. These Examples are intended to demonstrate the stability and state (phase) of matter of the multi-branched block copolymers of the present invention when combined with certain co-additives.

### Example 1: Determination of Hansen Solubility Parameters

### Examples 1A

Propoxylated sorbitol (MW=1342) was added into a steel autoclave (300 g) followed by KOH flake (5.2 g). The autoclave was sealed and heated to 230° F. and stripped under vacuum until the % water was less than 0.05%. At this point, the reactor was heated to 280° F. and 259 g of propylene oxide (PO) was added followed by 2042 g ethylene oxide (EO). When the reaction was complete, the mixture was vacuum stripped to remove residual oxide and removed from the reactor.

A round-bottomed flask was equipped with a nitrogen inlet, mechanical stirrer, and temperature probe. To the flask was charged the above product (100 g) and 6.8 g OSA (octenylsuccinic anhydride). The mixture was heated to 100° C. for 1 hour. When the anhydride was consumed, the product was cooled to room temperature and transferred to a container.

### Example 1B

Propoxylated sorbitol (MW=1342) was added into a steel autoclave (300 g) followed by KOH flake (5.3 g). The autoclave was sealed and heated to 230° F. and stripped under vacuum until the % water was less than 0.05%. At this point, the reactor was heated to 280° F. and 2070 g of ethylene oxide (EO) was added followed by 259 g propylene oxide (PO). When the reaction was complete, the mixture was vacuum stripped to remove residual oxide and removed from the reactor.

A round-bottomed flask was equipped with a nitrogen inlet, mechanical stirrer, and temperature probe. To the flask was charged the above product (100 g) and 3.6 g OSA (octenylsuccinic anhydride). The mixture was heated to 100° C. for 1 hour. When the anhydride was consumed, the product was cooled to room temperature and transferred to a container.

### General Procedure 1: Measurement of HSP Parameters for Example 1A and 1B

The Examples 1A and 1B were melted in a 60° C. oven. To a plastic centrifuge tube, 1 g of the polymer was added followed by 1 g of the relevant solvent as shown in Table 1A. The tubes were vortexed to mix thoroughly and allowed to sit for 24 h. After 24 h, the tubes were rated for solubility. If the sample was a clear liquid, it was rated as 1, if it was either cloudy or insoluble, it was rated as a 0. The HSPIP application was used to generate Hansen Solubility parameters for the polymer using the HSPIP software program. Other related wetting agents described in this patent were deemed structurally similar enough to read across the HSP. Wetting agent solubility ratings are provided in Table 1B.

TABLE 1A
Solubility Ratings

[symbol]

[symbol]

indicates data missing or illegible when filed

TABLE 1B
Experimentally Determined Hansen Solubility Parameters

| Solvent | Example 1A | Example 1B |
|---|---|---|
| Benzyl Alcohol | 1 | 1 |
| Benzyl Benzoate | 1 | 1 |
| Cyclhexanol | 0 | 0 |
| Diethylene Glycol | 0 | 0 |
| Dipropylene Glycol | 0 | 0 |
| Dimethyl Sulfoxide | 1 | 1 |
| Ethanolamine | 0 | 0 |
| Ethylene Glycol | 0 | 1 |
| Glycerol | 0 | 0 |
| Glycerol Carbonate | 1 | 1 |
| 2-Phenoxy Ethanol | 1 | 1 |
| Propylene Carbonate | 1 | 1 |
| Propylene Glycol | 0 | 0 |
| Deionized Water | 0 | 1 |
| N,N-Dimethylformamide | 0 | 1 |

| Sample | δD | δP | δH | Radius |
|---|---|---|---|---|
| Example 1A | 26.60 | 15.85 | 15.24 | 19.9 |
| Example 1B | 26.16 | 15.05 | 16.39 | 19.4 |

These measured values indicate intermediate to high values of δP and δH, indicating that diluents which have strong polar or hydrogen bonding parameters will facilitate efficient interaction and maximize solubility.

### Example 2

Propoxylated sorbitol (MW=4352) was added into a steel autoclave (600 g) followed by KOH flake (3.3 g). The autoclave was sealed and heated to 230° F. and stripped under vacuum until the % water was less than 0.05%. At this point, the reactor was heated to 280° F. and 248 g of propylene oxide (PO) was added followed by 816 g ethylene oxide (EO). When the reaction was complete, the mixture was vacuum stripped to remove residual oxide and neutralized with acetic acid.

Various formulations were made according to General Procedure 2 in order to evaluate formulation stability and determine the phase of matter when combined with co-additives as described herein.

### General Procedure 2

Example 2 was melted in a 50° C. oven. The indicated amount of the polymer was weighed into a test tube and propylene carbonate, a 40% urea solution, and Syn Lube 6485 (an alcohol ethoxylate commercially available from Milliken & Company of Spartanburg, S.C.) were added and the solution was mixed. If required, the tube was reheated in the oven to remelt all materials and they were mixed again. Once thoroughly mixed, the compositions were allowed to cool to room temperature and sit overnight. Comparative examples omitted either the polar or protic solvent from the formula or used them in ranges beyond the preferred ratios.

### Evaluation of Results

For each sample prepared, the phase of the material was observed. If the material flowed readily when inverted, it was determined to be a liquid. If it was clear but did not flow when inverted, it was determined to be a gel. If it was opaque and did not flow when inverted, it was determined to be a solid.

Table 2 provides wetting agent formulations and test results for various inventive and comparative examples.

TABLE 2
Wetting Agent Formulations and Phase Results

| | | Propylene | 40% urea | Syn Lube | Phase |
|---|---|---|---|---|---|
| | Example 2 | Carbonate | solution | 6485 | After |
| Sample | (g) | (g) | (g) | (g) | Overnight |
| Example 2A | 7.5 | 0.5 | 2 | 0.5 | Gel |
| Example 2B | 8.5 | 1.0 | 0.5 | 0.5 | Solid |
| Example 2C | 7.5 | 2.0 | 0.5 | 0.5 | Liquid |
| Example 2D | 7.6 | 1.2 | 1.2 | 0.5 | Liquid |
| Example 2E | 9.0 | 0.5 | 0.5 | 0.5 | Solid |
| Example 2F | 7.0 | 1.5 | 2 | 0.5 | Liquid |
| Example 2G | 7.0 | 1.9 | 1.1 | 0.5 | Liquid |
| Example 2H | 7.0 | 0.5 | 2.5 | 0.5 | Gel |
| Example 2I | 7.0 | 2.0 | 1 | 0.5 | Liquid |
| Example 2J | 8.4 | 0.5 | 1.5 | 0.5 | Solid |
| Example 2K | 7.6 | 1.9 | 0.5 | 0.5 | Liquid |
| Example 2L | 7.0 | 2.5 | 0.5 | 0.5 | Liquid |
| Comparative | 7.0 | 3.0 | 0.0 | 0.0 | Cloudy |
| Example 2A | | | | | Liquid |
| Comparative | 7.5 | 2.5 | 0.0 | 0.0 | Solid |
| Example 2B | | | | | |
| Comparative | 8.0 | 2.0 | 0.0 | 0.0 | Solid |
| Example 2C | | | | | |
| Comparative | 8.5 | 1.5 | 0.0 | 0.0 | Solid |
| Example 2D | | | | | |
| Comparative | 9.0 | 1.0 | 0.0 | 0.0 | Solid |
| Example 2E | | | | | |

The results illustrate multiple formulations which are liquid at room temperature. In particular, Example 2G, with a ratio of propylene carbonate to urea solution are approximately 2:1 is particularly favorable. Comparative Examples 2A through 2D show the importance of the protic solvent in the formula. Even at 30% of the total blend, a blend of Example 2 is a thick, cloudy solution. Lower propylene carbonate quantities are solids. A protic solvent is necessary to produce a clear liquid. Cloudy liquids might flow in the short term, but the cloudiness indicates partial insolubility that can lead to settling and separation on storage, which is also unfavorable.

### Example 3: Blends of Example 2 with Water

General procedure 2 was used as in the Examples above, except water was used instead of a 40% urea solution. Test results are provided in Table 3.

TABLE 3
Wetting Agent Formulations and Phase Results

| | | Propylene | | | |
|---|---|---|---|---|---|
| | Example 3 | Carbonate | Water | Syn Lube | Phase on |
| Sample | (g) | (g) | (g) | 6485 (g) | Sitting |
| Example 3A | 7.0 | 1.9 | 1.1 | 0.5 | Liquid |
| Comparative | 7.0 | 0.0 | 3.0 | 0.0 | Gel |
| Example 3A | | | | | |

Comparative Example 3A shows that when the protic solvent water is used in the absence of the polar propylene carbonate, a gel is formed. This demonstrates that both solvents are necessary to obtain a flowable formula.

### Example 4

General Procedure 2 was used, except the 40% urea solution was substituted with BIOSS, a biostimulant surfactant enhancer available from Advanced Biocatalytics. Formulations and test results are provided in Table 4.

TABLE 4
Wetting Agent Formulation and Phase Result

| | | Propylene | | | |
|---|---|---|---|---|---|
| | Example 2 | Carbonate | | Syn Lube | Phase on |
| Sample | (g) | (g) | BIOSS (g) | 6485 (g) | Sitting |
| Example 4 | 7.0 | 1.9 | 1.1 | 0.5 | Liquid |

### Example 5

Propoxylated glycerin (MW=1500) was added into a steel autoclave (300 g) followed by KOH flake (2.4 g). The autoclave was sealed and heated to 230° F. and stripped under vacuum until the % water was less than 0.05%. At this point, the reactor was heated to 280° F. and 300 g of propylene oxide (PO) was added followed by 598 g ethylene oxide (EO). When the reaction was complete, the mixture was vacuum stripped to remove residual oxide and neutralized with acetic acid.

General Procedure 2 was repeated, except the product described above was used as the block copolymer. Test results are provided in Table 5.

TABLE 5
Wetting Agent Formulation and Phase Result

| | | Propylene | | | |
|---|---|---|---|---|---|
| | Example 5 | Carbonate | | Syn Lube | Phase on |
| Sample | (g) | (g) | Water (g) | 6485 (g) | Sitting |
| Example 5 | 7.0 | 1.9 | 1.1 | 0.5 | Liquid |

In further various aspects of the invention, cosurfactants may be incorporated into intermediate hydrophobicity blends which may lead to improved wetting performance. In another aspect, low activity blends could be produced in solvents like water. Multiple applications of conventional surfactants may be used. It is also contemplated that drought stress could be lessened with biostimulants or other chemical treatments added to the formulations of the present invention. Further, a super-absorbent polymer could be incorporated into the ground to aid in water retention. In yet another aspect, the solid surfactants could be sold in a flake or powder that could be dosed into the tank. Furthermore, a small amount of PO could be incorporated into the EO block to lower the crystallinity.

All percentages and ratios are calculated by weight unless otherwise indicated. All percentages and ratios are calculated based on the total composition unless otherwise indicated.

It should be understood that every maximum numerical limitation given throughout this specification includes every lower numerical limitation, as if such lower numerical limitations were expressly written herein. Every minimum numerical limitation given throughout this specification will include every higher numerical limitation, as if such higher numerical limitations were expressly written herein. Every numerical range given throughout this specification will include every narrower numerical range that falls within such broader numerical range, as if such narrower numerical ranges were all expressly written herein.

All references, including publications, patent applications, and patents, cited herein are hereby incorporated by reference to the same extent as if each reference were individually and specifically indicated to be incorporated by reference and were set forth in its entirety herein.

The use of the terms “a” and “an” and “the” and similar referents in the context of describing the subject matter of this application (especially in the context of the following claims) are to be construed to cover both the singular and the plural, unless otherwise indicated herein or clearly contradicted by context. The terms “comprising,” “having,” “including,” and “containing” are to be construed as open-ended terms (i.e., meaning “including, but not limited to,”) unless otherwise noted. Recitation of ranges of values herein are merely intended to serve as a shorthand method of referring individually to each separate value falling within the range, unless otherwise indicated herein, and each separate value is incorporated into the specification as if it were individually recited herein. All methods described herein can be performed in any suitable order unless otherwise indicated herein or otherwise clearly contradicted by context. The use of any and all examples, or exemplary language (e.g., “such as”) provided herein, is intended merely to better illuminate the subject matter of the application and does not pose a limitation on the scope of the subject matter unless otherwise claimed. No language in the specification should be construed as indicating any non-claimed element as essential to the practice of the subject matter described herein.

Preferred embodiments of the subject matter of this application are described herein, including the best mode known to the inventors for carrying out the claimed subject matter. Variations of those preferred embodiments may become apparent to those of ordinary skill in the art upon reading the foregoing description. The inventors expect skilled artisans to employ such variations as appropriate, and the inventors intend for the subject matter described herein to be practiced otherwise than as specifically described herein. Accordingly, this disclosure includes all modifications and equivalents of the subject matter recited in the claims appended hereto as permitted by applicable law. Moreover, any combination of the above-described elements in all possible variations thereof is encompassed by the present disclosure unless otherwise indicated herein or otherwise clearly contradicted by context.

We claim:

1. A wetting agent formulation comprising: (1) a wetting agent that includes at least one multi-branched block copolymer, said block copolymer having a polyfunctional base which is an oxygen-containing compound having at least three ethylene oxide/propylene oxide block copolymer branches attached thereto, and (2) co-additives that include a combination of: (a) a polar solvent and (b) a protic solvent; wherein the wetting agent formulation is a flowable liquid at room temperature.

2. The wetting agent formulation of claim 1, wherein the polar solvent is selected from the group consisting of propylene carbonate, ethylene carbonate, dimethylsulfoxide, and combinations thereof.

3. The wetting agent formulation of claim 2, wherein the polar solvent is propylene carbonate.

4. The wetting agent formulation of claim 1, wherein the protic solvent is selected from the group consisting of water, glycerin carbonate, propylene glycol, ethylene glycol, urea, urea solutions, hydroxyethyl urea, hydroxyethyl urea solutions, and combinations thereof.

5. The wetting agent formulation of claim 1, wherein the polar solvent is propylene carbonate and the protic solvent is water.

6. The wetting agent formulation of claim 1, wherein the polyfunctional base is selected from the group consisting of a polyol, a polycarboxylic acid, and a lactone.

7. The wetting agent formulation of claim 6, wherein polyols are selected from the group consisting of tri- to octa-hydritic alcohols, glucose, sucrose, maltose, fructose, mannose, galactose, leucrose, and other alditol or sugar molecules.

8. The wetting agent formulation of claim 7, wherein the wherein tri- to octa-hydritic alcohols include pentaerythritol, glycerol, diglycerol, α-methylglucoside, sorbitol, xylitol, mannitol, erythritol, dipentaerythritol, and arabitol.

9. The wetting agent formulation of claim 1, wherein the amount of ethylene oxide is in the range from 40% to 90%.

10. The wetting agent formulation of claim 1, wherein the amount of propylene oxide is in the range from 10% to 60%.

11. The wetting agent formulation of claim 1, wherein the formulation further includes an additional compound that actively lowers the surface tension of water, a fertilizer, a pesticide, a biostimulant, a colorant, and combinations thereof.

12. The wetting agent formulation of claim 11, wherein the additional compound that actively lowers the surface tension of water includes a phenol ethoxylate, an alcohol ethoxylate, an alkyl sulfate, an alkyl phosphate, a linear ethylene oxide/propylene oxide block copolymer, a polyol, an additional unfunctionalized branched block copolymer, an alkylpolyglycoside, and combinations thereof.
